(19) United States
(12) Patent Application Publication
(10) Pub. No.: US 2023/0186334 A1
(43) Pub. Date: Jun. 15, 2023

(54) METHOD AND SYSTEM FOR DETERMINING GOODNESS OF PRICING INITIATIVE ON A DIGITAL PLATFORM

(71) Applicant: FLIPKART INTERNET PRIVATE LIMITED, Bengaluru (IN)

(72) Inventors: Ankur Kumar, Bangalore (IN); Supriti Das, Bhilai (IN); Nir Shahaf, Ramat HaSharon (IL); Shyam Beriwal, Bangalore (IN); Akarsh Jain, Bareilly (IN)

(73) Assignee: FLIPKART INTERNET PRIVATE LIMITED, Bengaluru (IN)

(21) Appl. No.: 18/075,797

(22) Filed: Dec. 6, 2022

(30) Foreign Application Priority Data
Dec. 11, 2021 (IN) 202141057733

(51) Int. Cl. G06Q 30/0201; G06F 18/24; G06F 18/2113

(52) U.S. Cl. CPC G06Q 30/0206; G06F 18/24765; G06F 18/2113

(57) ABSTRACT

The present disclosure relates to a method and system for determining goodness of pricing initiative on a digital platform. Said method comprises: (1) identifying, by a processor [102], a first set of products that are low churn products, brand rule independent products and competition independent products; (2) pre-clustering, by a clustering unit [108], the first set of products to identify pre-clusters such that the products within a pre-cluster are highly correlated products and products in different pre-clusters are independent of each other; (4) clustering, by the clustering unit [108], the pre-clusters based on predefined parameters to identify clusters; and (5) determining, by the processor [102], the goodness of the pricing initiative based at least on a testing of said pricing initiative based on the one first cluster.

### RELATED APPLICATION

This application claims priority under 35 U.S.C. § 119 to Indian Patent Application No. 202141057733, filed on Dec. 11, 2021, the entire contents of which are incorporated herein by reference

### FIELD OF THE DISCLOSURE

The present disclosure relates generally to the field of pricing initiatives for digital platforms. More particularly, the disclosure relates to methods and systems for determining the goodness of pricing initiatives on digital platforms.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Running pricing initiatives on digital platforms involves providing various schemes and offers to the customers and running various experiments on optimizing a correct pricing of a product or service that is available to the customers on a digital platform. For this purpose, various techniques are applied on online as well as offline platforms. This is easy to do on an offline store as the price quoted to one customer can be easily concealed from another customer. This is not simple at online platforms as the price shown to one user cannot be concealed from others. Further, if the different prices are shown to different user, it leads to wrong impression on users and bad word of mouth, ultimately leading to loss of trust and business.

Thus, it is important to keep a check on the performance of a price of a product or service so as to make sure that the price is optimized for all the users and also not kept different for different groups of users or customers.

There are a variety of existing methods and mechanisms by which digital platforms can measure the success of pricing initiatives that are run on digital platforms. One of the methods is by showing different pricing initiatives to different users or customers, that is, by linking different pricing initiatives to different user accounts. However, measuring goodness of pricing initiatives through this method is not recommended as exercising differential pricing for different customers can have legal implications owing to ethical practices. Further, it can also jeopardize the digital platforms image for users. For example, a user is shown a particular price of a product. In order to measure the goodness of a pricing initiative, the digital platform runs a method of differential pricing, say, based on location of another user who is sitting far from the geographical location of the first user. Now, if the two users have a conversation between the prices shown to them at the same time for the same product, they will perceive a mala fide intention of the digital platform. This may lead to loss of faith of users in the digital platform and will affect the business of the platform as well.

Thus, there exists an imperative need in the art to provide a system and method for determining goodness of pricing initiatives on digital platforms. This will help provide the digital platform to determine the effect of a pricing initiative and will also not affect a user's faith on the digital platform. Further, it will also save the digital platform from facing related legal implications.

### SUMMARY

This section is intended to introduce certain objects and aspects of the disclosed method and system in a simplified form and is not intended to identify the key advantages or features of the present disclosure.

One aspect of the present disclosure relates to a system for determining a goodness of a pricing initiative on a digital platform. The system comprises a processor configured to identify a first set of products, wherein the first set of products are low churn products, brand rule independent products and competition independent products and save the list of the first set of products in a memory storage device operably coupled to the processor. Further, a clustering unit pre-clusters the first set of products to identify a plurality of pre-clusters, wherein each pre-cluster includes a second set of one or more products from the first set of products that are highly correlated to all other products in said pre-cluster and the one or more products in the second set are independent of products in another pre-cluster, and saves the plurality of the pre-clusters in the memory storage device operably coupled to the clustering unit. Further, the clustering unit clusters the plurality of pre-clusters based on one or more predefined parameters to identify one first cluster and a plurality of second clusters and saves the one first cluster and the plurality of second clusters in the memory storage device operably coupled to the clustering unit. Finally, the processor determines the goodness of the pricing initiative based at least on a testing of said pricing initiative on the one first cluster.

Another aspect of the present disclosure relates to a method for determining a goodness of a pricing initiative on a digital platform. The method comprises: (1) identifying, by a processor, a first set of products, wherein the first set of products are low churn products, brand rule independent products and competition independent products; (2) pre-clustering, by a clustering unit, the first set of products to identify a plurality of pre-clusters, wherein each pre-cluster includes a second set of one or more products from the first set of products that are highly correlated to all other products in said pre-cluster and the one or more products in the second set are independent of products in another pre-cluster; (3) clustering, by the clustering unit, the plurality of pre-clusters based on one or more predefined parameters to identify one first cluster and a plurality of second clusters; and (4) determining, by the processor, the goodness of the pricing initiative based at least on a testing of said pricing initiative on the one first cluster.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1 illustrates an architecture of a system for determining a goodness of a pricing initiative on a digital platform, in accordance with exemplary embodiments of the present disclosure.

FIG. 2 illustrates an exemplary method flow diagram depicting a method for determining a goodness of a pricing initiative on a digital platform, in accordance with exemplary embodiments of the present disclosure.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein. Example embodiments of the present disclosure are described below, as illustrated in various drawings in which like reference numerals refer to the same parts throughout the different drawings.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, a “processor” or “processing unit” includes processing unit, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure.

Hereinafter, exemplary embodiments of the present disclosure will be described in detail with reference to the accompanying drawings so that those skilled in the art can easily carry out the solution provided by the present disclosure.

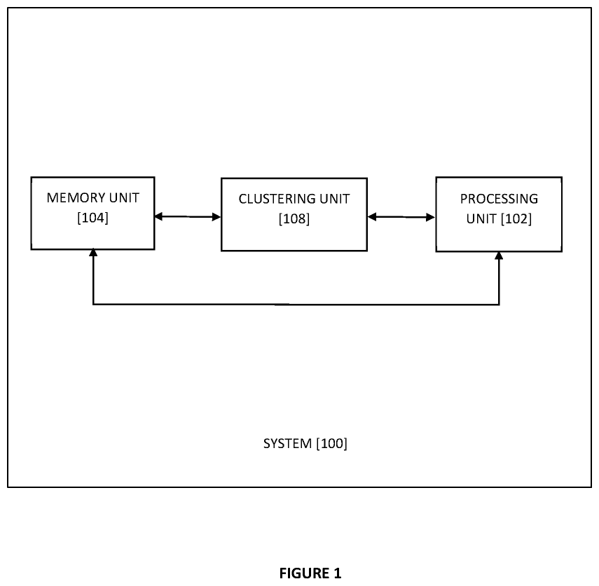

FIG. 1 illustrates an architecture of a system for determining a goodness of a pricing initiative on a digital platform. The system [100] provides an alternative approach for conducting AB testing of pricing initiatives in an ecommerce setup. Here, AB testing refers to a randomized experimentation process wherein two or more versions of a variable are shown to different segments of users at the same time to determine which version leaves the maximum impact and drive business metrics. It is also known as split testing. As shown, the system [100] comprises a processor [102], a memory unit [104], and a clustering unit [108]. All the components of the system [100] should be construed to be operably connected to each other unless indicated in the disclosure.

The processor [102] is configured to identify a first set of products. The first set of products have various characteristics such as they may be, brand rule independent products, competition independent products. Further, the products identified in this first set may be similar but non-cannibalising products and have low probability of churn. This ensures that the experiment is not influenced by competition or brand rules as well as has groups similar in behaviour competing with minimal cannibalization or cross influence on each other. In an implementation, the products in the first set are also selected by administrator of the digital platform. As the administrator has an in-depth knowledge of their products, they can also contribute in selection of the products to be included in said first set. Thus, the identification of the products to be included in the first set of products can be completely based on the processor [102], or completely based on the decision of the administrator of the digital platform, or may be partially based on the processor [102] and partially on human influence, that is, on the decision of the administrator of the digital platform.

In an implementation, the processor [102] identifies the first set of products based on one or more pre-defined rules. For example, a correlation matrix of daily Click Through Rate (CTR) of products are used to identify cannibalization between products. Similarly, other techniques can be used by the processor [102] to identify some other features of products to identify the first set of products. Thus, the processor [102] is configured to identify the first set of products based on the correlation matrix and saves this first set of products in the memory unit [104] which is operably coupled with the processor [102].

Since the products should have minimal or no interaction, it is important to check for and eliminate products which have inverse impact on Click Through Rate of other products as well as which drive or improve the Click Through Rate of other products through cross selling. For example, sale of lamps can drive sales of bulbs, etc. For this, an absolute correlation matrix is considered for eliminating high correlation in both directions, that is, standard and inverse impact on Click Through Rate. For this, the processor [102] is operably coupled with the memory unit [104] to fetch the information and process the first set of products. Thus, the processor [102] is configured to determine a correlation matrix of a daily click through rate between the plurality of products in the first set of products. Based on this, the processor [102] eliminates one or more products from the first set of products Now, each product in the first set of products is independent of cross influence of all other products. Further, the processor [102] is configured to save the list of the second set of products in the memory unit [104] operably coupled to the processor [102].

Further, the clustering unit [108] is configured to pre-cluster the first set of products to identify a plurality of pre-clusters, wherein each pre-cluster includes a second set of one or more products from the first set of products. These one or more products in the second set of products are highly correlated to all other products in said pre-cluster. Further, the one or more products in the second set are independent of products in another pre-cluster. For example, the products in the first set are: X1 toothbrush, X2 shampoo, X3 toothpaste, X1 mouthwash, X4 watch, and X2 conditioner, where X1, X2, X3, and X4 are corresponding brands of the products. Now the pre-clusters of the products formed by the clustering unit [108] can be the following: Pre-cluster 1 comprising X1 toothbrush, X3 toothpaste and X1 mouthwash, Pre-cluster 2 comprising X2 shampoo and X2 conditioner, Pre-cluster 3 comprising X4 watch. In operation, the clustering unit [108], in order to pre-cluster the second set of products, is operably connected to the processor [102] as well as the memory unit [104]. The pre-clustering happens on the basis a score which operates such that it would maximize the sum of absolute correlation. Thus, the score is constructed such that it would ensure that within a pre-cluster, that is a group of products, there is a set of products that have highest correlation with all other products within that group or pre-cluster, and also that there is no or minimal correlation between products of different groups or pre-clusters. for example, size of clusters is predefined, say, ‘n’. The score helps choosing a combination of the best ‘n’ products which have:

Max {Σ(correlation with products within cluster)−Σ(correlation with products outside the cluster)} per cluster.

Further, the clustering unit [108] is configured to save the plurality of the pre-clusters in the memory unit [104] operably coupled to the clustering unit [108]. Further, the clustering unit [108] clusters the plurality of pre-clusters based on one or more predefined parameters to identify one first cluster and a plurality of second clusters. For this, it normalizes the one first cluster and the plurality of second clusters based on one or more normalizing factors for each of the one first cluster and the plurality of second clusters. These one or more normalizing factors include at least one of an age, an inventory, a Cost to MRP difference, a Revenue Profit, a Click Through Rate and an Average selling price/MRP band. Also, the pre-clusters can be clustered using a K-means clustering process to ensure that groups of very similarly behaving pre-clusters are obtained. Further, the clustering unit [108] saves the one first cluster and the plurality of second clusters in the memory unit [104] operably coupled to the clustering unit [108]. In an implementation, the first cluster is a test group for conducting experiments, and the plurality of second clusters are the control groups for benchmarking performance. Finally, the processor [102] determines the goodness of the pricing initiative based on a testing of said pricing initiative on the one first cluster. This involves measuring by comparing the performance of the test group or the first cluster against all the control groups or the plurality of second clusters. For example, there is one first cluster and two second clusters. The testing of pricing initiative is done of the first cluster. In this testing, say, a 4% lift is achieved. This 4% lift means the variation in the test parameters before test period and after test period. Further, say, for the two second clusters, a 1% lift is achieved. This difference of 3% lift is now attributed to the pricing initiative. In this way, the goodness of a pricing initiative is measured.

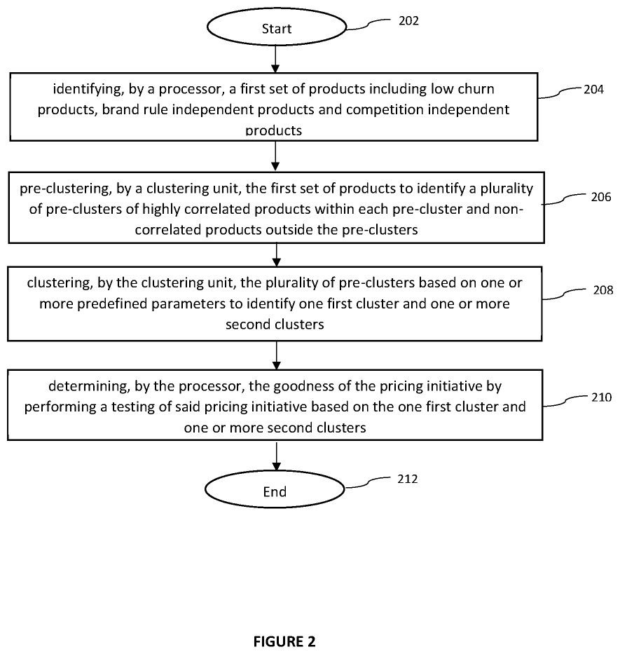

Referring to FIG. 2, an exemplary method flow diagram depicting a method for determining a goodness of a pricing initiative on a digital platform is shown. The method starts at step 202 and goes to step 204. At step 204, the processor [102] identifies a first set of products. This first set of products may be low churn products, brand rule independent products and competition independent products. This ensures that the experiment is not influenced by competition or brand rules as well as has groups similar in behaviour competing with minimal cannibalization or cross influence on each other. It is pertinent to note that these features of products are only exemplary and there can be other features that can be taken into account such as, manual controls of programs, pricing or offers running on products, stockouts, new inventory, cost changes, limitations against conducting a customer cohort level AB, dynamic demand in and out of events, volatile traffic or seasonality, cannibalization, etc. In an implementation, the products in the first set are also selected by administrator of the digital platform. As the administrator has an in-depth knowledge of their products, they can also contribute in selection of the products to be included in said first set. Thus, the identification of the products to be included in the first set of products can be completely based on the processor [102], or completely based on the decision of the administrator of the digital platform, or may be partially based on the processor [102] and partially on human influence, that is, on the decision of the administrator of the digital platform.

Also, in an implementation, at step 204, the processor [102] identifies the first set of products based on one or more pre-defined rules. For example, a correlation matrix of daily Click Through Rate (CTR) of products is used to identify cannibalization between products. Similarly, other techniques can be used by the processor [102] to identify some other features of products to identify the first set of products. Thus, the processor [102] identifies the first set of products based on the correlation matrix. Further, the processor [102] saves this first set of products in the memory unit [104] which is operably coupled with the processor [102].

Also, since the sets of products should have minimal or no interaction, it is important to check for and eliminate products which have inverse impact on Click Through Rate of other products as well as which drive or improve the Click Through Rate of other products through cross selling. For example, it is highly probable that a shampoo drives the sales of a conditioner as customers usually purchase shampoo and conditioners together, and therefore, such related products should not be included in the same set. For this, an absolute correlation matrix can be considered for eliminating high correlation in both directions, that is, standard and inverse impact on Click Through Rate.

Thus, at step 204, the processor [102] first determines a correlation matrix of a daily click through rate between the plurality of products in the first set of products, and then eliminates the one or more products from the first set of products based on the correlation matrix. Now, each product in the first set of products is independent of cross influence of all other products in the first set of products. After this, the processor [102] saves the list of the first set of products in the memory unit [104] operably coupled to the processor [102]. Alternatively, it sends the processed information to the clustering unit [108].

At step 206, the clustering unit [108] pre-clusters the first set of products to identify a plurality of pre-clusters. Each of these pre-clusters includes the products that are highly correlated to all other products in same said pre-cluster. Also, this pre-clustering is done in a manner that there is minimal cases of high correlation with other pre-clusters. The pre-clustering happens on the basis a score which operates such that it would maximize the sum of absolute correlation. After obtaining the pre-clusters, the clustering unit [108] can save the plurality of the pre-clusters in the memory unit [104] operably coupled to the clustering unit [108]. Alternatively, it can also use the pre-clusters to further processing without saving the pre-clusters.

At step 208, the clustering unit [108] clusters the plurality of pre-clusters based on one or more predefined parameters to identify one first cluster and a plurality of second clusters. For this, it normalizes the one first cluster and the plurality of second clusters based on one or more normalizing factors for each of the one first cluster and the plurality of second clusters. These one or more normalizing factors include at least one of an age, an inventory, a Cost to MRP difference, a Revenue Profit, a Click Through Rate and an Average selling price/MRP band. After clustering the plurality of pre-clusters, the clustering unit [108] can save the one first cluster and the plurality of second clusters in the memory unit [104] operably coupled to the clustering unit [108]. Alternatively, the clustering unit can also send the cluster information to the processor [102] directly without saving the information in the memory unit [104] operably connected with the clustering unit [108].

Finally, at step 210, the processor [102] determines the goodness of the pricing initiative based on a testing of said pricing initiative on the one first cluster, and the process ends at step 212. For example, there is one first cluster and two second clusters. The testing of pricing initiative is done of the first cluster. In this testing, say, a 4% lift is achieved. This 4% lift means the variation in the test parameters before test period and after test period. Further, say, for the two second clusters, a 1% lift is achieved. This difference of 3% lift is now attributed to the pricing initiative. In this way, the goodness of a pricing initiative is measured.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

We claim:

1. A method for determining a goodness of a pricing initiative on a digital platform, the method comprising:
identifying, by a processor [102], a first set of products, wherein the first set of products are low churn products, brand rule independent products and competition independent products;
pre-clustering, by a clustering unit [108], the first set of products to identify a plurality of pre-clusters, wherein each pre-cluster includes a second set of one or more products from the first set of products, that are highly correlated to all other products in said pre-cluster and the one or more products in the second set are independent of products in another pre-cluster;
clustering, by the clustering unit [108], the plurality of pre-clusters based on one or more predefined parameters to identify one first cluster and a plurality of second clusters; and
determining, by the processor [102], the goodness of the pricing initiative based at least on a testing of said pricing initiative on the one first cluster.

2. The method as claimed in claim 1, wherein identifying, by the processor [102], the first set of products is based on one or more pre-defined rules.

3. The method as claimed in claim 1, wherein the pre-clustering, by the clustering unit [108], the first set of products to identify a plurality of pre-clusters, comprises:
determining a correlation matrix of a daily click through rate between the plurality of products in the first set of products; and
eliminating the one or more products from the first set of products to identify one or more pre-clusters of second set of products based on the correlation matrix.

4. The method as claimed in claim 1 wherein clustering, by the clustering unit [108], the plurality of pre-clusters based on one or more predefined parameters to identify the one first cluster and the plurality of second clusters further comprises:
normalizing the one first cluster and the plurality of second clusters based on one or more normalizing factors for each of the one first cluster and the plurality of second clusters.

5. The method as claimed in claim 4, wherein the one or more normalizing factors include at least one of an age, an inventory, a Cost to MRP difference, a Revenue Profit, a Click Through Rate and an Average selling price/MRP band.

6. A system [100] for determining a goodness of a pricing initiative on a digital platform, the system [100] comprising:
a processor [102] configured to:
identify a first set of products, wherein the first set of products are low churn products, brand rule independent products and competition independent products;
save the list of the first set of products in a memory unit [104] operably coupled to the processor [102];
a clustering unit [108] configured to:
pre-cluster the first set of products to identify a plurality of pre-clusters, wherein each pre-cluster includes a second set of one or more products from the first set of products, that are highly correlated to all other products in said pre-cluster and the one or more products in the second set are independent of products in another pre-cluster;
save the plurality of the pre-clusters in the memory unit [104] operably coupled to the clustering unit [108];
cluster the plurality of pre-clusters based on one or more predefined parameters to identify one first cluster and a plurality of second clusters;
save the one first cluster and the plurality of second clusters in the memory unit [104] operably coupled to the clustering unit [108]; and
the processor [102] configured to determine the goodness of the pricing initiative based at least on a testing of said pricing initiative on the one first cluster.

7. The system as claimed in claim 6, wherein the processor [102] identifies the first set of products based on one or more pre-defined rules.

8. The system as claimed in claim 6 wherein the clustering unit [108], for pre-clustering the first set of products to identify a plurality of pre-clusters, is configured to:
determine a correlation matrix of a daily click through rate between the plurality of products in the first set of products; and
eliminate the one or more products from the first set of products to identify one or more pre-clusters of second set of products based on the correlation matrix.

9. The system as claimed in claim 6, wherein the clustering unit [108], for clustering the plurality of pre-clusters based on one or more predefined parameters to identify the one first cluster and the plurality of second clusters, is further configured to:
normalize the one first cluster and the plurality of second clusters based on one or more normalizing factors for each of the one first cluster and the plurality of second clusters.

10. The system as claimed in claim 9, wherein the one or more normalizing factors include at least one of an age, an inventory, a Cost to MRP difference, a Revenue Profit, a Click Through Rate and an Average selling price/MRP band.
